(19) United States
(12) Patent Application Publication
(10) Pub. No.: US 2015/0091724 A1
(43) Pub. Date: Apr. 2, 2015

(54) Mandown Automatic SOS Speaker Device

(71) Applicant: Radio-Tone Company Limited, Hong Kong (HK)

(72) Inventors: Wai Shing MOK, HONG KONG (HK); Wing Hong Joe CHUNG, HONG KONG (HK)

(73) Assignee: Radio-Tone Company Limited

(21) Appl. No.: 14/497,346

(22) Filed: Sep. 26, 2014

(30) Foreign Application Priority Data
Sep. 29, 2013 (CN) 201310454890.9

(51) Int. Cl. G08B 21/02; H04B 1/38; H04R 1/02

(52) U.S. Cl. CPC G08B 21/02; H04R 1/02; H04B 1/3827
USPC 340/539.11

(57) ABSTRACT

The present invention provides a mandown automatic SOS speaker device configured to be used with a radio transceiver.

### CROSS-REFERENCE TO RELATED APPLICATION

This application claims benefit under 35 U.S.C. §119(b) of Chinese patent application having Serial No. 201310454890.9 filed Sep. 29, 2013, which is hereby incorporated by reference herein in its entirety.

### FIELD OF INVENTION

This invention relates to a device for automatically transmitting distress signals in accidents.

### BACKGROUND OF INVENTION

Although mobile communications are highly-developed nowadays, radio transceiver still finds its values in our daily life. The reason therefor is mainly based on the following three major characteristics of radio transceiver: 1. Paging—radio transceiver can accomplish single point to multipoint communication simultaneously, enable rallying multitudes at one's calling; 2. Rapidness—radio transceiver is a simple device which enables communication upon pressing a speaker button, as contrasted with mobile that requires dialing and connection; 3. Reliability—at outdoors activities, mobiles often fail for communication due to the problems of signal coverage of the base station. Radio transceiver works in a communication network established by group signals, which provides stable and reliable communication within a network formed by a group.

Emergency alarming is a function generally equipped in advanced radio transceivers that are mainly applied in wireless communication devices for disciplinary forces such as the police, the fire service etc. When a user is at an accident, the radio transceiver can transmit distress signals “V . . . V . . . V . . . ” upon pressing of the emergency alarming button by the user, thus achieving the purpose of real-time supporting the radio transceiver user to seek for assistance. Nevertheless, for certain perilous situations, a radio transceiver user may fall down and even sink into coma due to injury and may thus be unable to press the emergency alarming button, hence missing the chance of being rescued or sending out alerts.

There exist radio transceivers that have equipped the function of reporting mandown. Some of these products have this function designed for specific radio transceiver systems, making it difficult to transplant the function among radio transceivers of different models. Else, some may use complex single chip microcomputer technology which leads to high production cost. Therefore, it is necessary to provide a device for automatically transmitting distress signals that is configured to be used with a radio transceiver which lacking the emergency alarming function.

### SUMMARY OF INVENTION

In the first aspect, the present invention provides a body status detection unit comprising four unidirectional rolling ball tilt switches configured as “X and inverted V” groups in a three-dimension arrangement. The adjacent angle between the two unidirectional rolling ball tilt switches in the X group is 60 degrees or 120 degrees, while the adjacent angle between two of the unidirectional rolling ball tilt switches in the inverted-V group is 60 degrees. The adjacent angle between the X group and the inverted-V group is 90 degrees.

In the second aspect, the present invention provides a mandown automatic SOS speaker device configured to be used with a radio transceiver. The speaker device comprises a body status detection unit as described in the first aspect of the present invention, an emergency alarming trigger, a buzzer and a central processing unit. The central processing unit is adapted to accept signals from the emergency alarming trigger or the body status detection unit; activate the emergency alarming function; and simultaneously transmit distress signals via the radio transceiver or the buzzer. In one embodiment of the present invention, the mandown automatic SOS speaker device further comprises a power management unit and a power source; wherein the power source can independently provide electricity to the buzzer under the control of the power management unit.

In the third aspect, the present invention provides an automatic emergency alarming radio transceiver device which comprises the mandown automatic SOS speaker device as described in one aspect of the present invention.

### BRIEF DESCRIPTION OF FIGURES

Non-limiting examples will now be described with reference to the accompanying figures, in which:

FIG. 1 shows a schematic diagram of the mandown automatic SOS speaker device according to one embodiment of the present invention.

FIGS. 2A and 2B shows the structure of the body status detection unit according to the same embodiment of the present invention in which FIG. 2A shows the top view and FIG. 2B shows the side view.

FIG. 3 shows a schematic diagram of the central processing unit according to the same embodiment of the present invention.

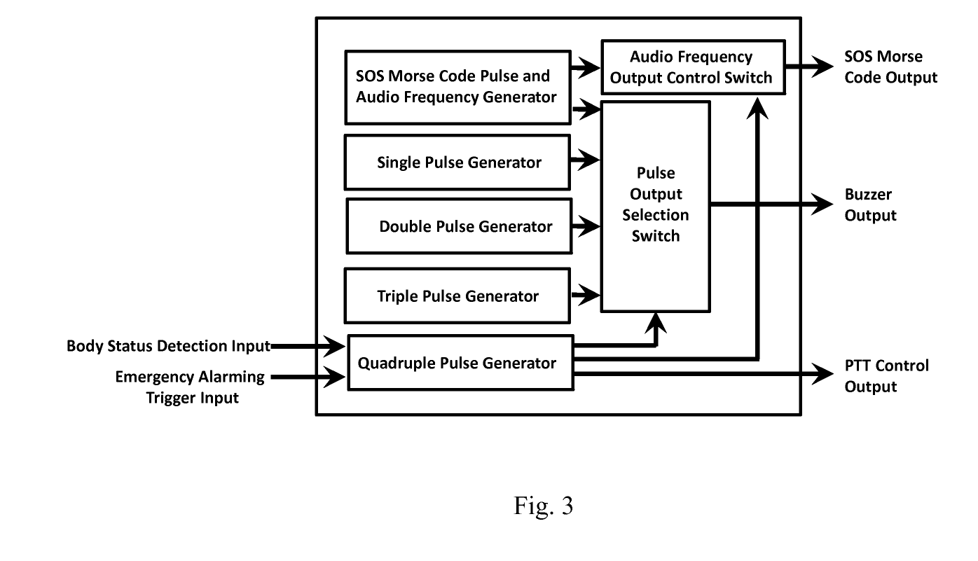

FIG. 4 shows a schematic diagram of the power management unit according to the same embodiment of the present invention.

In these figures, similar features are referred by similar reference numerals.

### DETAILED DESCRIPTION OF THE PREFERRED EMBODIMENTS

### Embodiment 1

The present invention provides a mandown automatic SOS speaker device configured to be used with conventional radio transceivers of all models and all brands available in the market. When these conventional radio transceivers are coupled with the mandown automatic SOS speaker device of the present invention, not only an emergency alarming button is added as in advanced radio transceivers that enables user to manually seek for assistance, but also an intelligent function for user to automatically seek for help. After switching on the radio transceiver coupled with the mandown automatic SOS speaker device, the mandown automatic SOS speaker device of the present invention will proactively monitor the status of the user throughout the journey. When the user is at accident and becomes incapacitated to press the “emergency alarming button” to seek for assistance, the intelligent function will automatically transmit distress signals to anyone nearby or at distance, thus providing further protection to the safety of the user.

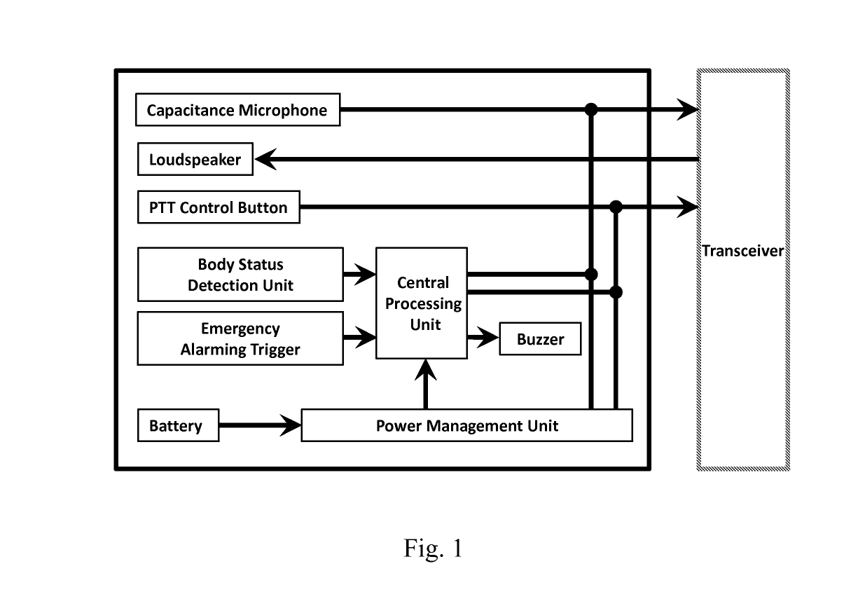

In one embodiment of the present invention, an internal module is shown in FIG. 1 in which apart from a PTT (Push-to-talk) control button, a microphone and a loudspeaker, the internal module also includes a body status detection unit, an emergency alarming trigger, a buzzer, a power management unit, a power source and a central processing unit, etc.

In general communication, a radio transceiver installed with the mandown automatic SOS speaker device of the present invention performs in no different way than a conventional radio transceiver. A user can press the PTT control button to initiate communication.

When encountering an accident, the user can manually press the emergency alarming button for more than 3 seconds to manually activate the emergency alarming function.

When the user falls and is unable to press the emergency alarming button due to the accident, the body status detection unit of the mandown automatic SOS speaker device of the present invention can detect the change of the status of the user's body and then automatically activate the emergency alarming function.

Once the emergency alarming function of the mandown automatic SOS speaker device of the present invention has been activated, the speaker device would automatically and intermittently transmit internationally recognized SOS Morse code to anyone at distance via the radio transceiver. Meanwhile, the speaker device would also automatically and intermittently transmit internationally recognized SOS Morse code to anyone nearby via the built-in buzzer. Even in the case where the power supply of the radio transceiver is depleted, the buzzer will continually transmit the distress sound signals until the emergency alarming function has been reset or the built-in battery has been depleted. As such, the purpose of automatically transmitting distress signals to anyone nearby or at distance is thus achieved.

### Embodiment 2

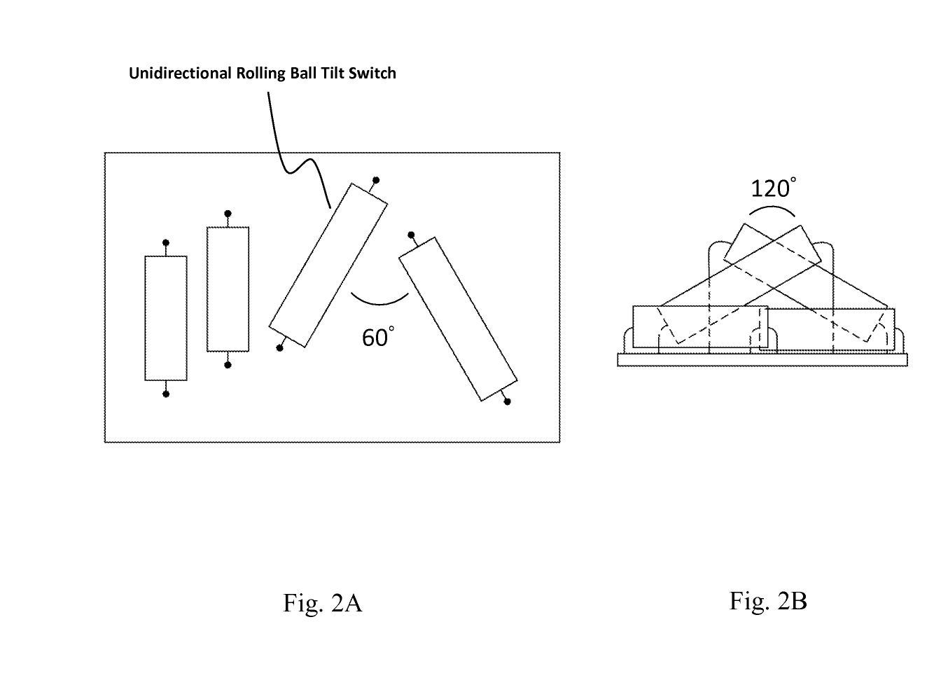

In one embodiment of the present invention, a body status detection unit is composed of 4 unidirectional rolling ball tilt switches. The body status detection unit is configured as “X and inverted V” groups in a three-dimension arrangement as shown in FIGS. 2A and 2B. The adjacent angle between the two unidirectional rolling ball tilt switches in the X group is 60 degrees or 120 degrees and the adjacent angle between the two unidirectional rolling ball tilt switches in the inverted-V group is 60 degrees. The adjacent angle between the X group and the inverted-V group is 90 degrees. The body status detection unit can provide realtime omnibearing level detection of a human body in the upright position. When the body of the user inclines in any direction at an angle greater than 60 degrees, the body status detection unit would transmit a trigger signal to the central processing unit.

### Embodiment 3

In one embodiment of the present invention, a central processing unit includes a central processor, a single pulse generator, a double pulse generator, a quadruple pulse generator, a pulse output selector switch, a SOS Morse code pulse generator and a SOS Morse code audio frequency generator, etc. In a preferred embodiment, the central processor can operate at a ultra-low power consumption.

The single pulse generator generates single pulse that drives the buzzer to produce an alert signal “B . . . ” in response to the activation of the power source and the resets of emergency alarming function of the mandown automatic SOS speaker device of the present invention.

The double pulse generator generates two pulses that drive the buzzer to produce an alert signal “B . . . B . . . ” in response to the manual activation of the emergency alarming function of the mandown automatic SOS speaker device of the present invention.

The quadruple pulse generator generates four pulses that drive the buzzer to produce an alert signal “B . . . B . . . B . . . B . . . ” to remind the user of the mandown automatic SOS speaker device of the present invention that the automatic emergency alarming function is about to be activated.

The SOS Morse code pulse generator generates 20 WPM SOS Morse code pulses that drive the buzzer to produce SOS Morse code sound signals.

The SOS Morse code audio frequency generator generates 20 WPM SOS Morse code audio signals.

The central processor is responsible for processing the manual and automatic emergency alarming triggering signals. On pressing the emergency alarming button for more than 3 seconds, manual emergency alarming triggering signals will be transmitted to the central processing unit. When the central processor of the central processing unit receives the aforesaid triggering signals, it will first manipulate a pulse output selection switch to instruct the double pulse generator for driving the buzzer to produce an alert signal “B . . . B . . . ”. Then, the central processor controls an audio frequency output control switch and generates a PTT control signal. By controlling the coupled transceiver, SOS Morse audio frequency distress signals can be intermittently transmitted to anyone at distance. Also, by controlling the pulse output selection switch, the buzzer can intermittently transmit SOS Morse code distress signals generated from the SOS Morse code pulse and audio frequency generators to anyone nearby, until the emergency alarming function has been reset or the built-in battery has been depleted.

When the central processing unit receives the triggering signals of the body status detection unit, the central processor of the central processing unit will first continuously monitor the inclination status of the user's body. If the user's body continuously inclines for more than 40 seconds, the central processor will control the pulse output selection switch to instruct the quadruple pulse generator for driving the buzzer to produce a first alert signal “B . . . B . . . B . . . B . . . ”. If the central processor continues to receive the triggering signal in the next 10 seconds, the central processor will control the pulse output selection switch to instruct the quadruple pulse generator for driving the buzzer to produce a second alert signal “B . . . B . . . B . . . B . . . ”. If the central processor no longer receives any continuous triggering signals, it will be reset. Otherwise, if the central processor still continues to receive the triggering signals in the next 10 seconds, the central processor will control the audio frequency output control switch and generate a PTT control signal. By controlling the coupled transceiver, the SOS Morse audio frequency distress signals can intermittently be transmitted to anyone at distance. Also, by controlling the pulse output selection switch, the buzzer can intermittently transmit SOS Morse code distress signals generated from the SOS Morse code pulse and audio frequency generators to anyone nearby, until the emergency alarming function has been reset or the built-in battery has been depleted.

### Embodiment 4

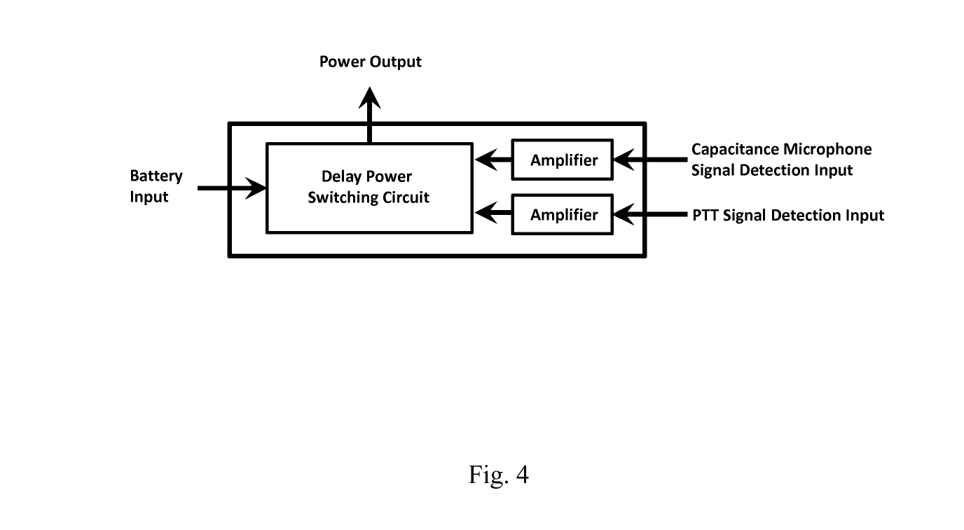

One embodiment of the present invention includes a power management unit as shown in FIG. 4. By real-time detection of the PTT control output of the transceiver and the weak signal of sound input, the power management unit can detect the switch status of the coupled radio transceiver, control the delay power switching circuit and control the power of entire power source of the mandown automatic SOS speaker device of the present invention. This allows the power source of the mandown automatic SOS speaker device to independently provide electricity to the buzzer to continuously transmit distress sound signals when the power of the radio transceiver has been depleted.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

What is claimed is:

1. A body status detection unit comprising four unidirectional rolling ball tilt switches configured as “X and inverted-V” groups in a three-dimension arrangement; wherein the adjacent angle between the two of said unidirectional rolling ball tilt switches in said X group is 60 degrees or 120 degrees; the adjacent angle between two of said unidirectional rolling ball tilt switches in said “inverted-V” group is 60 degrees; and the adjacent angle between said X group and said “person” group is 90 degrees.

2. A mandown automatic SOS speaker device configured to be used with a radio transceiver comprising said body status detection unit of claim 1, an emergency alarming trigger, a buzzer and a central processing unit; wherein said central processing unit is adapted to accept signals from said emergency alarming trigger or said body status detection unit; activate the emergency alarming function; and simultaneously transmit distress signals via said radio transceiver or said buzzer.

3. The mandown automatic SOS speaker device of claim 2 further comprising a power management unit and a power source; wherein said power source can independently provide electricity to said buzzer under the control of said power management unit.

4. An automatic emergency alarming radio transceiver device comprising said mandown automatic SOS speaker device of claim 2.
